(19) United States
(12) Patent Application Publication
(10) Pub. No.: US 2010/0332960 A1
(43) Pub. Date: Dec. 30, 2010

(54) METHOD AND APPARATUS FOR ORGANIZING IDENTIFYING INFORMATION FOR WEB-BASED RESOURCES

(75) Inventors: Stuart O. Goldman, Scottsdale, AZ (US); Veena B. Mendiratta, Oak Brook, IL (US)

Correspondence Address: FAY SHARPE/LUCENT, 1228 Euclid Avenue, 5th Floor, The Halle Building, Cleveland, OH, 44115-1843, US

(73) Assignee: ALCATEL-LUCENT USA INC., Murray Hill, NJ (US)

(21) Appl. No.: 12/491,706

(22) Filed: Jun. 25, 2009

(51) Int. Cl. G06F 17/30; G06F 17/00

(52) U.S. Cl. 715/205; 707/769; 707/759; 707/708

(57) ABSTRACT

A method for organizing identifying information for web-based resources may include: a) initializing an organizing tool and a web browser from a user device in operative communication with a network; b) searching the network for web-based resources associated with a search query by accessing the web search engine via the web browser; c) receiving a results list from the web search engine at the user device in response to the search query; and d) creating an organized file with the organizing tool based on the results list, the organized file including a root node with identifying information for the search query and a first level selectively populated with identifying information for one or more web-based resources included in the results list. A system for organizing identifying information for web-based resources may include a network, an organizing tool; and a user device.

### BACKGROUND

This disclosure relates to a method and apparatus for organizing identifying information for web-based resources. While this disclosure describes exemplary embodiments of organizing identifying information stemming from results lists generated from search queries, and will be thus described with specific reference thereto, it will be appreciated that the disclosed concepts may have usefulness in organizing identifying information for web-based resources based on other types of search, navigation, or data mining activities. For example, the concepts may be useful in organizing identifying information for web-based resources associated with i) drilling down a results list from a search query, ii) a navigation sequence during a web browsing session or a portion of the session, or iii) data mining activities associated with web crawling or spidering.

By way of background, the Internet has bought us powerful search capabilities, but often the search results in many potential web locations which the user then needs to manually visit to better determine applicability. After performing a web search and receiving several uniform resource identifiers (URIs) that match the search criteria, a user may follow either of the following paths: i) visit all or some subset of the URIs in the search results, or ii) visit a URI in the search results, click on a link and go to another URI, and repeat this process many times. The first set of actions represents a breadth first search and the second represents a depth first search. Generally a user follows a combination of breadth and depth strategies in the search process. URIs may include a uniform resource locator (URL), a uniform resource name (URN), or both. Often URIs are simply referred to as URLs regardless of the form of the information.

The next action in the search session is usually dependent on the current state, where state is defined to mean the relevance of the current page content to the subject of the search. The technical problem is that a user can follow many paths through the search tree. However, the user often needs to go back and trace a different leg of the tree. Currently the only way to navigate back up a leg of the tree is to use the BACK button on the browser or re-enter the URL manually. In doing this the user often mentally loses track of all the search possibilities. Often the user ends up re-visiting the same non-applicable sites numerous times and can become frustrated by the apparent waste of time. Such frustration may cause the user to prematurely abandon the search without finding the best site. Furthermore, the sheer amount of potential sites that could be investigated may hide the very data being sought.

Based on the foregoing, a solution that collects identifying information for web pages and other web-based resources associated with research using the web browser is desirable. Additionally, a solution that that overcomes at least a portion of the drawbacks associated with known approaches to such research using current web browsers is desirable.

### SUMMARY

In one aspect, a method for organizing identifying information for web-based resources is provided. In one embodiment, the method includes: a) initializing an organizing tool and a web browser from a user device in operative communication with a network, the web browser providing the user device with access to a web search engine and other web-based resources hosted by one or more components of the network; b) searching the network for web-based resources associated with a first search query by accessing the web search engine via the web browser; c) receiving a first results list from the web search engine at the user device in response to the first search query; and d) creating a first organized file with the organizing tool based on the first results list, the first organized file including a first root node with identifying information for the first search query and a first level selectively populated with identifying information for one or more web-based resources included in the first results list.

In another aspect, an apparatus for organizing identifying information for web-based resources is provided. In one embodiment, the apparatus includes a network, an organizing tool; and a user device in operative communication with the network and the organizing tool. In this embodiment, the network includes one or more components hosting a web search engine and other web-based resources and the user device includes a web browser providing a user with access to the web search engine and the web-based resources associated with the network. The user device permits the user to initialize the organizing tool and the web browser and search the network for web-based resources associated with a first search query by accessing the web search engine via the web browser. The user device receives a first results list from the web search engine in response to the first search query. The organizing tool creates a first organized file based on the first results list, the first organized file including a first root node with identifying information for the first search query and a first level selectively populated with identifying information for one or more web-based resources included in the first results list.

In another aspect, a method for organizing identifying information for World Wide Web (WWW) resources is provided. In one embodiment, the method includes: a) initializing an organizing tool and a web browser from a computing device in operative communication with the Internet, the web browser providing the computing device with access to a web search engine and other WWW resources; b) searching the Internet for WWW resources associated with a search query by accessing the web search engine via the web browser; c) receiving a results list from the web search engine at the computing device in response to the search query; d) creating an organized file with the organizing tool based on the results list, the organized file including a root node with identifying information for the search query and a first level selectively populated with identifying information for one or more WWW resources included in the results list; e) displaying the results list on the computing device via the web browser; f) selecting a first hypertext link associated with a first WWW resource from the results list to display the first WWW resource on the computing device via the web browser, the first WWW resource including one or more hypertext links; g) selecting a second hypertext link associated with a second WWW resource from the first WWW resource; and h) populating a second level of the organized file with identifying information for the second WWW resource and hierarchically associating the identifying information for the second WWW resource in the second level with the identifying information for the first WWW resource in the first level using the organizing tool.

Further scope of the applicability of the present invention will become apparent from the detailed description provided below. It should be understood, however, that the detailed description and specific examples, while indicating preferred embodiments of the invention, are given by way of illustration only, since various changes and modifications within the spirit and scope of the invention will become apparent to those skilled in the art.

### DESCRIPTION OF THE DRAWINGS

The present invention exists in the construction, arrangement, and combination of the various parts of the device, and steps of the method, whereby the objects contemplated are attained as hereinafter more fully set forth, specifically pointed out in the claims, and illustrated in the accompanying drawings in which:

FIG. 1 is a diagram showing an exemplary embodiment of a tree display for exemplary identifying information for web-based resources associated with an exemplary search query and exemplary drilling down through the search results;

FIG. 2 is a flow chart of an exemplary embodiment of a process for organizing identifying information for web-based resources;

FIG. 3, in conjunction with FIG. 2, is a flow chart of another exemplary embodiment of a process for organizing identifying information for web-based resources;

FIG. 4, in conjunction with FIGS. 2 and 3, is a flow chart of yet another exemplary embodiment of a process for organizing identifying information for web-based resources;

FIG. 5, in conjunction with FIGS. 2-4, is a flow chart of still another exemplary embodiment of a process for organizing identifying information for web-based resources;

FIG. 6 is a block diagram of an exemplary embodiment of an system for organizing identifying information for web-based resources;

FIG. 7 is a flow chart of an exemplary embodiment of a process for organizing identifying information for World Wide Web (WWW) resources;

FIG. 8, in conjunction with FIG. 7, is a flow chart of another exemplary embodiment of a process for organizing identifying information for WWW resources;

FIG. 9, in conjunction with FIGS. 7 and 8, is a flow chart of yet another exemplary embodiment of a process for organizing identifying information for WWW resources.

### DETAILED DESCRIPTION

Various embodiments of methods and systems for organizing identifying information for web-based resources are described herein. Commercially-available user devices, such as desktop computers, laptop computers, mobile devices, and like devices, may be adapted to implement techniques for organizing the identifying information. While various exemplary user devices are identified herein, the techniques for organizing the identifying information can be applied to any user device capable of accessing a network using web browser. Additionally, the techniques for organizing the identifying information can be client-based or server-based in relation to the user device and the network.

In one embodiment, an organizing tool may be provided to automatically create a “search tree map” for the user to assist in searching by eliminating or at least dramatically reducing the ineffective backtracking that currently occurs. The tool can create such a map by using an algorithm that would add nodes to a tree structure as a user visits a new web-based resource. Each visited node could be clickable in the map so the user can easily return to the selected resource. The tree structure could be displayed in a separate window that could optionally pop up when the user starts a new search. The map could pop up all the time or could be invoked when the user wants aid in performing a search. Another variation of the implementation would be to “offer” the map when the number of “hits” returned exceeds a user settable threshold.

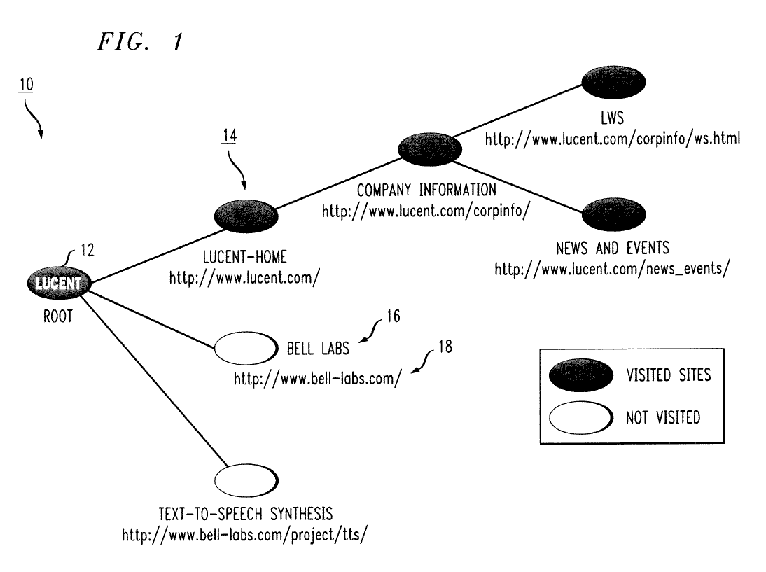

Referring now to the drawings wherein the showings are for purposes of illustrating the exemplary embodiments only and not for purposes of limiting the claimed subject matter, FIG. 1 depicts an exemplary embodiment of a tree display 10 for exemplary identifying information for web-based resources associated with an exemplary search query and exemplary drilling down through the search results. The display shows a simple search tree map 10 that was triggered by the user searching for the term “Lucent.” A root node 12 identifies the “Lucent” search query that was submitted to a web search engine, such as Google, Yahoo! Search, Bing (formerly known as MSN Live Search), AOL Search by Google, Ask by Teoma, or any suitable search engine on any server. The results list 14 returned by the web search engine are represented by the three nodes in the vertical column. Actual results lists may include more or less items. Typical results lists include tens, hundreds, or even thousands of items.

The tool may flag or highlight nodes in the tree to show that the corresponding web-based resource was visited. For example, the nodes in the tree that were visited are darkened and the nodes that were not visited are not filled. Any suitable technique may be used to flag or highlight visited nodes. The tree display 10 may include a URN 16 corresponding to the web-based resource, a URL 18 corresponding to web-based resource, or both. The tool may also permit the user to annotate any node with additional information, such as “poor example” or “best general explanation.”

The exemplary search tree map represents the state of the web research work at an instant in time. The user can create multiple maps when performing unrelated searches. The tool will automatically name the map based on the search target, but the user can of course rename the map and file with a more appropriate name if desired.

Because the map is a computer file stored in the computer. The map file may be in extensible markup language (XML) format or any suitable format. As a file, the tree can be saved, shared with others, and suspended and restarted at a later time from where it was left off. The tree could be annotated to capture additional information like an annotated bibliography or other comments. The algorithm may also provide the capability to: i) prune the tree at any point, ii) allow multiple roots, iii) indicate when a sub-node has previously been visited upstream in the tree, iv) move a sub-tree to another parent elsewhere in the tree, v) explicitly specify which links are added to the search tree, and vi) annotate each node with additional information.

Besides making the web search process more systematic, there are several other potential applications for such a web-based algorithm. For example, it can be used as a research tool, cataloging tool, education tool, notes tool, etc. The tool could be a separate application that launches a web browser, such as Internet Explorer by Microsoft, Google Chrome by Google, Firefox by Mozilla, Opera by Opera Software, Safari by Apple, or any suitable web browser. In this arrangement, the web browser may be viewed as a proxy service to the organizing tool. The tool monitors browsing activities, including keeping track of web searches and web-based resources visited. The web searches may be based submission of a search query to a web search engine that returns a corresponding results list identifying web-based resources associated with the search query. The web-based resources may include web pages, images, music, video, information, and other types of files. The web search and web-based resources may be in relation to any type of network to which accessible the user has access, including a local area network (LAN), wide area network (WAN), metropolitan area network (MAN), the entire Internet, or any combination of networks. Similarly, the web search and web-based resources can be limited or restricted to any subset of any network or combination of networks. The tool can generate a map displaying identifying information for web-based resources associated with the search query, results lists, subsequent browsing, or any combination thereof.

When the user starts the tool application (e.g. using a clickable button on the users homepage), a separate window and corresponding file may open that would provide the user with a view of the current search tree. This window could provide editing controls for the tree, such as: i) add selected URLs from the currently active browser screen, including the URL of the current page, ii) start a new search tree, iii) prune a sub-tree, iii) move a sub-tree, iv) add/edit annotations at specific nodes, v) save the tree to a file, vi) read a tree in from a file, vii) email the tree, and viii) start a keyword search across the pages recorded in a specified sub-tree. The nodes that had a hit could be displayed directly on the tree (the search can be launched in the background). Direct parent-child linkage relationships could be displayed in a distinctive manner (e.g., in a specified color or line style). In addition, the application may allow multiple search trees to be open at one time.

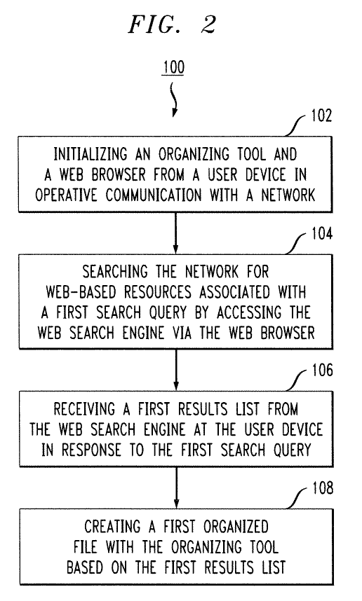

With reference to FIG. 2, an exemplary embodiment of a process 100 for organizing identifying information for web-based resources begins at 102 where an organizing tool and a web browser may be initialized from a user device in operative communication with a network. The web browser may provide the user device with access to a web search engine and other web-based resources hosted by one or more components of the network. The identifying information may include a URN, a URL, both URN and URL, or any suitable identifying information for the corresponding web-based resource. A web-based resource may include a web page, an image file, a video file, an audio file, a text file, any combination thereof, or any type of file accessible from the user device over the network via the web browser. The user device may include a desktop computer, a laptop computer, a personal digital assistant (PDA), a mobile device, any suitable type of computing device.

At 104, the network may be searched for web-based resources associated with a first search query by accessing the web search engine via the web browser. Next, a first results list may be received from the web search engine at the user device in response to the first search query (106). At 108, a first organized file may be created by the organizing tool based on the first results list. The first organized file including a first root node with identifying information for the first search query and a first level selectively populated with identifying information for one or more web-based resources included in the first results list.

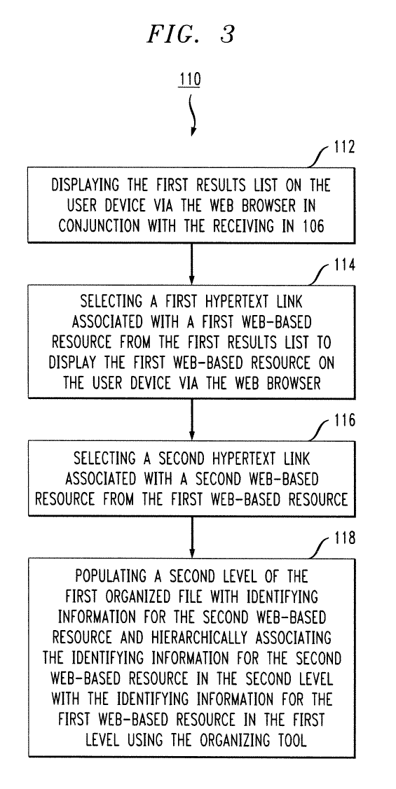

With reference to FIGS. 2 and 3, another exemplary embodiment of a process 110 for organizing identifying information for web-based resources also includes displaying the first results list on the user device via the web browser in conjunction with the receiving in 106 (112). At 114, a first hypertext link associated with a first web-based resource may be selected from the first results list to display the first web-based resource on the user device via the web browser. The first web-based resource may include one or more hypertext links. Next, a second hypertext link associated with a second web-based resource is selected from the first web-based resource (116). At 118, a second level of the first organized file may be populated with identifying information for the second web-based resource. The identifying information for the second web-based resource in the second level may be hierarchically associated with the identifying information for the first web-based resource in the first level using the organizing tool. The hierarchical relationship may be shown by linking nodes for web-based resources together with a line, by indenting the second level web-based resource in relation to the corresponding first level web-based resource, by textual information, or any suitable technique showing a parent-child type relationship.

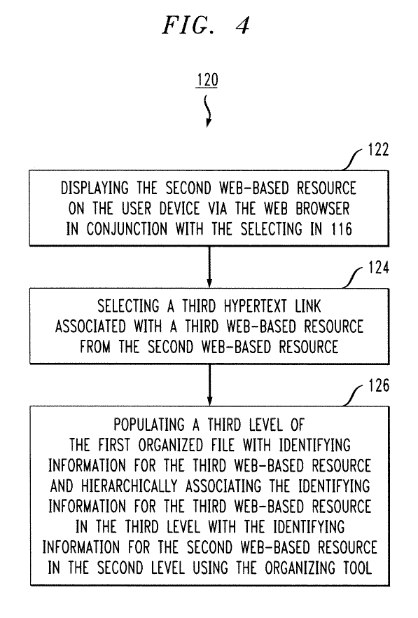

With reference to FIGS. 2-4, yet another exemplary embodiment of a process 120 for organizing identifying information for web-based resources also includes displaying the second web-based resource on the user device via the web browser in conjunction with the selecting in 116 (122). The second web-based resource may include one or more hypertext links. At 124, a third hypertext link associated with a third web-based resource may be selected from the second web-based resource. Next, a third level of the first organized file may be populated with identifying information for the third web-based resource (126). The identifying information for the third web-based resource in the third level may be hierarchically associated with the identifying information for the second web-based resource in the second level using the organizing tool.

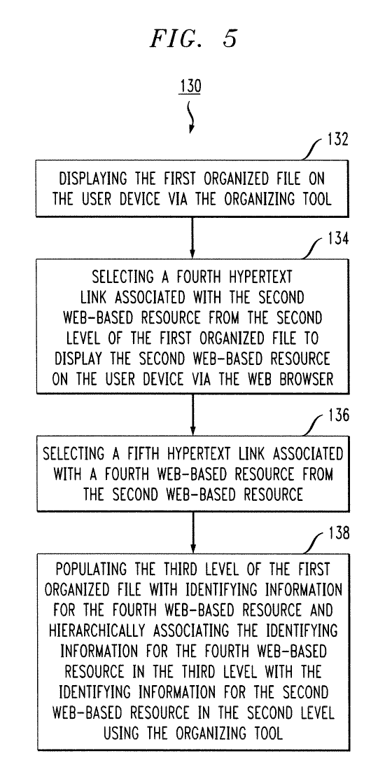

With reference to FIGS. 2-5, still another exemplary embodiment of a process 130 for organizing identifying information for web-based resources also includes displaying the first organized file on the user device via the organizing tool (132). At 134, a fourth hypertext link associated with the second web-based resource from the second level of the first organized file may be selected to display the second web-based resource on the user device via the web browser. Next, a fifth hypertext link associated with a fourth web-based resource may be selected from the second web-based resource (136). At 138, the third level of the first organized file may be populated with identifying information for the fourth web-based resource. The identifying information for the fourth web-based resource in the third level may be hierarchically associated with the identifying information for the second web-based resource in the second level using the organizing tool.

In another embodiment, the first results list may be displayed on the user device via the web browser in conjunction with the receiving in 106. In the embodiment being described, the identifying information for each web-based resource may be flagged in the first organized file via the organizing tool to indicate that the web-based resources were not visited in conjunction with the creating in 108.

In yet another embodiment, the identifying information for the first web-based resource may be flagged in the first organized file via the organizing tool to indicate the first web-based resource was visited in conjunction with the selecting in 114. In the embodiment being described, the second web-based resource may be displayed on the user device via the web browser in conjunction with the selecting in 116. Next, the identifying information for the second web-based resource may be flagged in the first organized file via the organizing tool to indicate the second web-based resource was visited.

Similarly, in still another embodiment, the third web-based resource may be displayed on the user device via the web browser in conjunction with the selecting in 124. In the embodiment being described, the identifying information for the third web-based resource may be flagged in the first organized file via the organizing tool to indicate the third web-based resource was visited.

Likewise, in still yet another embodiment, the fourth web-based resource may be displayed on the user device via the web browser in conjunction with the selecting in 136. In the embodiment being described, the identifying information for the fourth web-based resource may be flagged in the first organized file via the organizing tool to indicate the fourth web-based resource was visited.

In another embodiment, the hierarchical association of the identifying information for the second web-based resource may be changed in the first organized file using the organizing tool to identifying information for a different web-based resource. Similarly, in yet another embodiment, the hierarchical association of the identifying information for the third web-based resource may be change in the first organized file using the organizing tool to identifying information for a different web-based resource.

In yet another embodiment, the first organized file may be displayed on the user device via the organizing tool. In the embodiment being described, a third hypertext link associated with a third web-based resource may be selected from the first level of the first organized file to display the third web-based resource on the user device. The third web-based resource being included in the first results list separate from the first web-based resource.

In another embodiment, identifying information for at least one web-based resource may be pruned from the first level of the first organized file using the organizing tool. In other embodiments, the identifying information for at least one web-based resource may be pruned from any level of the first organized file using the organizing tool.

In still another embodiment, the network may be searched for web-based resources associated with a second search query by accessing the web search engine via the web browser. In the embodiment being described, a second results list may be received from the web search engine at the user device in response to the second search query. Next, a second root node with identifying information for the second search query may be added to the first organized file with the organizing tool. In the embodiment, a subordinate level selectively populated with identifying information for one or more web-based resources included in the second results list may be added to the second root node with the organizing tool.

In still yet another embodiment, the network may be searched for web-based resources associated with a second search query by accessing the web search engine via the web browser. In the embodiment being described, a second results list may be received from the web search engine at the user device in response to the second search query. Next, a second organized file may be created by the organizing tool based on the second results list. The second organized file including a second root node with identifying information for the second search query and a subordinate level selectively populated with identifying information for one or more web-based resources included in the second results list.

In yet another embodiment, one or more web-based resources may be selected from the first results list using the organizing tool in conjunction with the populating of the first level of the first organized file in 108. In still another embodiment, the identifying information for at least one web-based resource in the first organized file may be annotated with ad hoc information using the organizing tool. In still yet another embodiment, the first organized file may be saved to a storage device accessible to the user device via the organizing tool.

In another embodiment, the first results list may be displayed on a first display device of the user device via the web browser. In the embodiment being described, the first organized file may be displayed on a second display device of the user device via the organizing tool. In an alternate embodiment, the first organized file may be displayed on the first display device of the user device via the organizing tool.

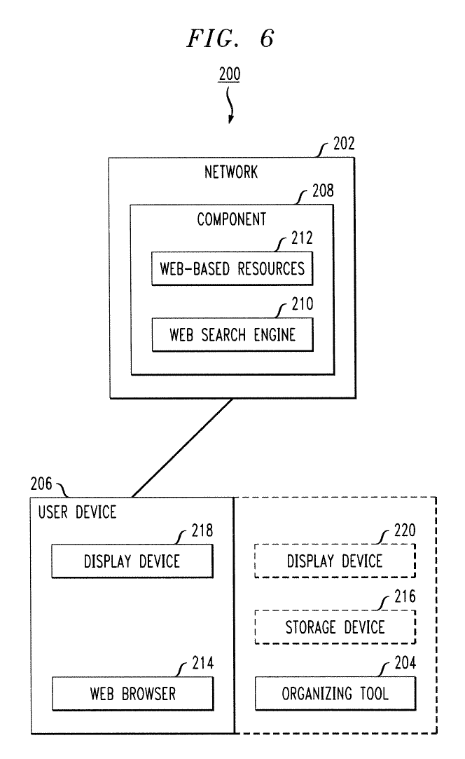

With reference to FIG. 6, an exemplary embodiment of a system 200 for organizing identifying information for web-based resources may include a network 202, an organizing tool 204, and a user device 206 in operative communication with the network 202 and the organizing tool 204. The network 202 may include one or more components 208 hosting a web search engine 210 and other web-based resources 212. The user device 206 may include a web browser 214 providing a user with access to the web search engine 210 and the web-based resources 212 associated with the network 202. The organizing tool 204 may be client-based and included with the user device 206 or may be server-based and included with a component 208 of the network 202.

The user device 206 may permit the user to initialize the organizing tool 204 and the web browser 214 and search the network 202 for web-based resources 212 associated with a first search query by accessing the web search engine 210 via the web browser 214. The user device 206 may receive a first results list from the web search engine 210 in response to the first search query. The organizing tool 204 may create a first organized file based on the first results list. The first organized file including a first root node with identifying information for the first search query and a first level selectively populated with identifying information for one or more web-based resources included in the first results list.

In another embodiment, the user device 206 may display the first results list via the web browser 214. The user device 206 may permit the user to select a first hypertext link associated with a first web-based resource 212 from the first results list to display the first web-based resource 212 on the user device 206 via the web browser 214. The first web-based resource 212 including one or more hypertext links. The user device 206 may permit the user to select a second hypertext link associated with a second web-based resource 212 from the first web-based resource 212. The organizing tool 204 may populate a second level of the first organized file with identifying information for the second web-based resource 212. The identifying information for the second web-based resource 212 in the second level may be hierarchically associated with the identifying information for the first web-based resource in the first level by the organizing tool 204.

In a further embodiment, the user device 206 may display the second web-based resource via the web browser. The second web-based resource 212 including one or more hypertext links. The user device 206 may permit the user to select a third hypertext link associated with a third web-based resource 212 from the second web-based resource 212. The organizing tool 204 may populate a third level of the first organized file with identifying information for the third web-based resource 212. The identifying information for the third web-based resource 212 in the third level may be hierarchically associated with the identifying information for the second web-based resource 212 in the second level by the organizing tool 204.

In yet a further embodiment, the user device 206 may display the first organized file via the organizing tool 204. The user device 206 may permit the user to select a fourth hypertext link associated with the second web-based resource 212 from the second level of the first organized file to display the second web-based resource 212 on the user device 206 via the web browser 214. The user device 206 may permit the user to select a fifth hypertext link associated with a fourth web-based resource 212 from the second web-based resource 212. The organizing tool 204 may populate the third level of the first organized file with identifying information for the fourth web-based resource 212. The identifying information for the fourth web-based resource 212 in the third level may be hierarchically associated with the identifying information for the second web-based resource 212 in the second level by the organizing tool 204.

In another embodiment, the user device 206 may display the first organized file via the organizing tool 204. The organizing tool 204 may permit the user to select a third hypertext link associated with a third web-based resource 212 from the first level of the first organized file to display the third web-based resource 212 on the user device 206. The third web-based resource 212 being included in the first results list separate from the first web-based resource 212.

In yet another embodiment, the organizing tool 204 may permit the user to prune identifying information for at least one web-based resource 212 from the first level of the first organized file. In other embodiments, the organizing tool 204 may permit the user to prune identifying information for at least one web-based resource 212 from any level of the first organized file.

In still another embodiment, the user device 206 may permit the user to search the network 202 for web-based resources 212 associated with a second search query by accessing the web search engine 210 via the web browser 214. The user device 206 may receive a second results list from the web search engine 210 in response to the second search query. The organizing tool 204 may add a second root node with identifying information for the second search query to the first organized file. The organizing tool 204 may also add a subordinate level selectively populated with identifying information for one or more web-based resources included in the second results list to the second root node.

In still yet another embodiment, the user device 206 may permit the user to search the network 202 for web-based resources associated with a second search query by accessing the web search engine 210 via the web browser 214. The user device 206 may receive a second results list from the web search engine 210 in response to the second search query. The organizing tool 204 may create a second organized file based on the second results list. The second organized file including a second root node with identifying information for the second search query and a subordinate level selectively populated with identifying information for one or more web-based resources 212 included in the second results list.

In another embodiment, the system 200 includes a storage device 216 in operative communication with the user device 206 for saving the first organized file via the organizing tool 204. The storage device 216 may be included with the user device 206 or may be included with a component 208 of the network 202.

In yet another embodiment, the user device 206 may include a first display device 218 for displaying the first results list via the web browser 214. In a further embodiment, the user device 206 may include a second display device 220 for displaying the first organized file via the organizing tool 204. In an alternate embodiment, the first organized file may be displayed on the first display device 218 via the organizing tool.

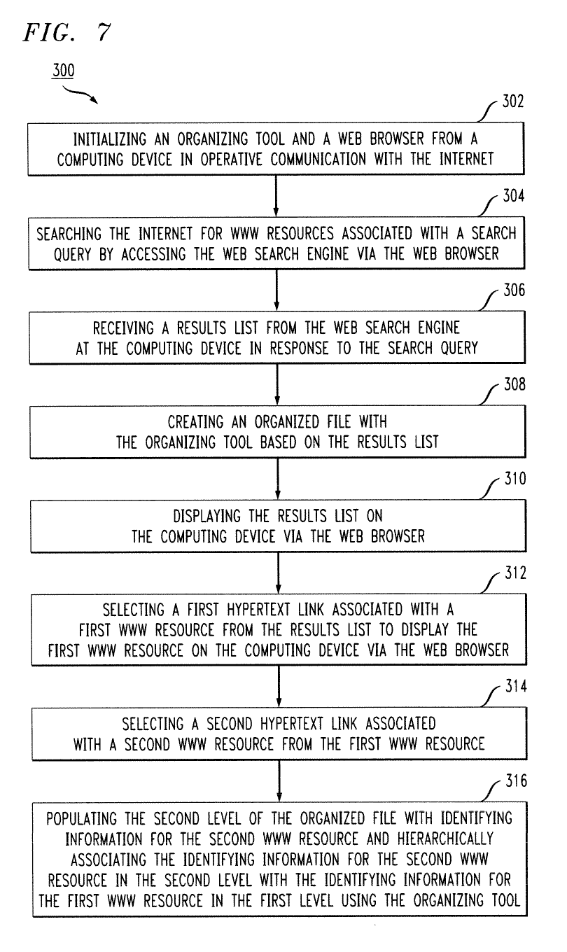

With reference to FIG. 7, an exemplary embodiment of a process 300 for organizing identifying information for World Wide Web (WWW) resources begins at 302 where an organizing tool and a web browser may be initialized from a computing device in operative communication with the Internet. The web browser may provide the computing device with access to a web search engine and other WWW resources. The identifying information may include a URN, a URL, both URN and URL, or any suitable identifying information for the corresponding WWW resource. A WWW resource may include a web page, an image file, a video file, an audio file, a text file, any combination thereof, or any type of file accessible from the computing device over the Internet via the web browser. The computing device may include a desktop computer, a laptop computer, a personal digital assistant (PDA), a mobile device, or any suitable type of user device.

At 304, the Internet may be searched for WWW resources associated with a search query by accessing the web search engine via the web browser. Next, a results list may be received from the web search engine at the computing device in response to the search query (306). At 308, an organized file may be created by the organizing tool based on the results list. The organized file including a root node with identifying information for the search query and a first level selectively populated with identifying information for one or more WWW resources included in the results list.

Next, the results list may be displayed on the computing device via the web browser (310). At 312, a first hypertext link associated with a first WWW resource may be selected from the results list to display the first WWW resource on the computing device via the web browser. The first WWW resource may include one or more hypertext links. Next, a second hypertext link associated with a second WWW resource may be selected from the first WWW resource (314). At 316, a second level of the organized file may be populated with identifying information for the second WWW resource. The identifying information for the second WWW resource in the second level may be hierarchically associated with the identifying information for the first WWW resource in the first level using the organizing tool.

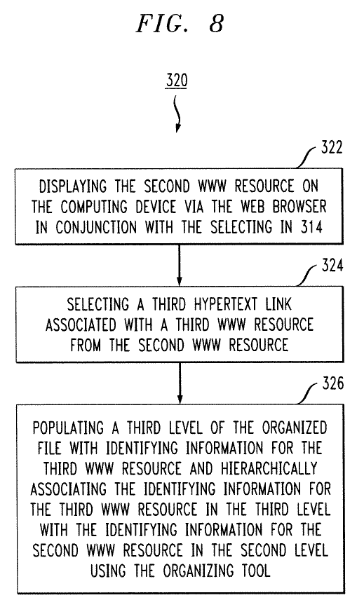

With reference to FIGS. 7 and 8, another exemplary embodiment of a process 320 for organizing identifying information for WWW resources also includes displaying the second WWW resource on the computing device via the web browser in conjunction with the selecting in 314 (322). The second WWW resource may include one or more hypertext links. At 324, a third hypertext link associated with a third WWW resource may be selected from the second WWW resource. Next, a third level of the organized file may be populated with identifying information for the third WWW resource (326). The identifying information for the third WWW resource in the third level may be hierarchically associated with the identifying information for the second WWW resource in the second level using the organizing tool.

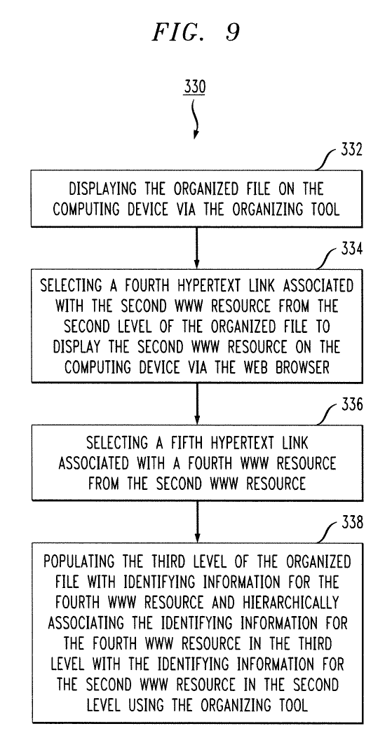

With reference to FIGS. 7-9, yet another exemplary embodiment of a process 330 for organizing identifying information for WWW resources also includes displaying the organized file on the computing device via the organizing tool (332). At 334, a fourth hypertext link associated with the second WWW resource may be selected from the second level of the organized file to display the second WWW resource on the computing device via the web browser. Next, a fifth hypertext link associated with a fourth WWW resource may be selected from the second WWW resource (336). At 338, the third level of the organized file may be populated with identifying information for the fourth WWW resource. The identifying information for the fourth WWW resource in the third level may be hierarchically associated with the identifying information for the second WWW resource in the second level using the organizing tool.

In another embodiment, the identifying information for each WWW resource may be flagged in the organized file via the organizing tool to indicate that the WWW resources were not visited in conjunction with the creating in 308. In the embodiment being described, the identifying information for the first WWW resource may be flagged in the organized file via the organizing tool to indicate the first WWW resource was visited in conjunction with the selecting in 312. Next, the second WWW resource may be displayed on the computing device via the web browser in conjunction with the selecting in 314. In the embodiment being described, the identifying information for the second WWW resource may be flagged in the organized file via the organizing tool to indicate the second WWW resource was visited.

Similarly, in yet another embodiment, the third WWW resource may be displayed on the computing device via the web browser in conjunction with the selecting in 324. In the embodiment being described, the identifying information for the third WWW resource may be flagged in the organized file via the organizing tool to indicate the third WWW resource was visited.

Likewise, in still another embodiment, the fourth WWW resource may be displayed on the computing device via the web browser in conjunction with the selecting in 336. In the embodiment being described, the identifying information for the fourth WWW resource may be flagged in the organized file via the organizing tool to indicate the fourth WWW resource was visited.

In another embodiment, the hierarchical association of the identifying information for the second WWW resource may be changed in the organized file using the organizing tool to be hierarchically associated with identifying information for a different WWW resource. Similarly, in yet another embodiment, the hierarchical association of the identifying information for the third WWW resource may be changed in the organized file using the organizing tool to identifying information for a different WWW resource.

In yet another embodiment, the organized file may be displayed on the computing device via the organizing tool. In the embodiment being described, a third hypertext link associated with a third WWW resource may be selected from the first level of the organized file to display the third WWW resource on the computing device. The third WWW resource being included in the results list separate from the first WWW resource.

In another embodiment, identifying information for at least one WWW resource may be pruned from the first level of the organized file using the organizing tool. In other embodiments, the identifying information for at least one WWW resource may be pruned from any level of the organized file using the organizing tool.

In still another embodiment, one or more WWW resources may be selected from the results list using the organizing tool in conjunction with the populating of the first level of the organized file in 308. In still another embodiment, the identifying information for at least one WWW resource in the organized file may be annotated with ad hoc information using the organizing tool. In still yet another embodiment, the organized file may be saved to a storage device accessible to the computing device via the organizing tool.

In another embodiment, the results list may be displayed on a first display device of the computing device via the web browser. In the embodiment being described, the organized file may be displayed on a second display device of the computing device via the organizing tool. In an alternate embodiment, the organized file may be displayed on the first display device of the computing device via the organizing tool.

The above description merely provides a disclosure of particular embodiments of the invention and is not intended for the purposes of limiting the same thereto. As such, the invention is not limited to only the above-described embodiments. Rather, it is recognized that one skilled in the art could conceive alternative embodiments that fall within the scope of the invention.

1. (canceled)

2. The method of claim 26, further comprising:
selecting a first hypertext link associated with a first web resource from the search results to display the first web resource on the user device, the first hypertext link corresponding to the first identifier, the first web resource including one or more hypertext links;
selecting a third hypertext link associated with a third web resource from the first web resource, the third hypertext link corresponding to the third identifier.

3. The method of claim 2, further comprising:
displaying the third web resource on the user device in conjunction with the selecting of the third hypertext link, the third web resource including one or more hypertext links;
selecting a fourth hypertext link associated with a fourth web resource from the third web resource, the fourth hypertext link corresponding to a fourth identifier of web resources; and
populating a third level of the tree structure with the fourth identifier and hierarchically associating the fourth identifier with the third identifier in the second level of the tree structure.

4. The method of claim 3, further comprising:
displaying the tree structure on the user device;
selecting a second hypertext link associated with the second web resource from the second level of the tree structure to display the second web resource on the user device, the second hypertext link corresponding to the second identifier;
selecting a fifth hypertext link associated with a fifth web resource from the second web resource, the fifth hypertext link corresponding to a fifth identifier of web resources; and
populating the third level of the tree structure with the fifth identifier and hierarchically associating the fifth identifier with the second identifier in the second level of the tree structure.

5. The method of claim 2, further comprising:
flagging the first identifier for the first web resource in the tree structure to indicate the first web resource was visited in conjunction with the selecting of the first hypertext link;
displaying the second web resource on the user device via the web browser in conjunction with the selecting of the second hypertext link; and
flagging the second identifier for the second web resource in the tree structure to indicate the second web resource was visited.

6. The method of claim 2, further comprising:
displaying the tree structure on the user device; and
selecting a sixth hypertext link associated with a sixth web resource from the first level of the tree structure to display the sixth web resource on the user device, the sixth hypertext link corresponding to a sixth identifier of web resources, the sixth identifier included in the search results separate from the first and second identifiers.

7. The method of claim 2, further comprising:
changing the hierarchical association of the second identifier for the second web resource in the tree structure to associated the second identifier with a different web resource.

8. The method of claim 26, further comprising:
displaying the search results on the user device in conjunction with the receiving of the search results from the web search engine; and
flagging the identifiers for each web resource in the tree structure to indicate that the web resources were not visited in conjunction with the providing of displayable information to the user device.

9. The method of claim 26, further comprising:
pruning the corresponding identifier for at least one web resource from the first level of the tree structure.

10. The method of claim 26, further comprising:
receiving, from the web search engine, second search results responsive to a second query from the user device, the second search results including additional identifiers of web resources;
providing to the user device displayable information concerning a second node of the tree structure, wherein the additional identifiers are selectively arranged at the first level of the tree structure relative to the second node.

11. The method of claim 26, further comprising:
receiving, from the web search engine, second search results responsive to a second query from the user device, the second search results including additional identifiers of web resources; and
providing to the user device displayable information concerning a second tree structure having at least one node, wherein the additional identifiers are selectively arranged at a first level of the second tree structure relative to the corresponding at least one node.

12. The method of claim 26, further comprising:
selecting one or more web resources from the search results in conjunction with the providing of displayable information to the user device.

13. The method of claim 26, further comprising:
annotating the identifier for at least one web resource in the tree structure with ad hoc information.

14. (canceled)

15. The apparatus of claim 27, further comprising:
a storage device in operative communication with the organizing tool for saving the tree structure.

16. The apparatus of claim 27, wherein the user device includes a first display device for displaying the search results.

17. The apparatus of claim 16 wherein the user device includes a second display device for displaying the tree structure.

18. The apparatus of claim 16 wherein the first display device is also for displaying the tree structure.

19. (canceled)

20. The method of claim 28, further comprising:
displaying the third WWW resource on the computing device in conjunction with the selecting of the third hypertext link, the third WWW resource including one or more hypertext links;
selecting a fourth hypertext link associated with a fourth WWW resource from the third WWW resource, the fourth hypertext link corresponding to a fourth identifier of web resources; and
populating a third level of the tree structure with the fourth identifier and hierarchically associating the fourth identifier with the third identifier in the second level of the tree structure.

21. The method of claim 20, further comprising:
displaying the tree structure on the computing device;
selecting a second hypertext link associated with the second WWW resource from the second level of the tree structure to display the second WWW resource on the computing device, the second hypertext link corresponding to the second identifier;
selecting a fifth hypertext link associated with a fifth WWW resource from the second WWW resource, the fifth hypertext link corresponding to a fifth identifier of web resources; and
populating the third level of the tree structure with the fifth identifier and hierarchically associating the fifth identifier with the second identifier in the second level of the tree structure.

22. The method of claim 28, further comprising:
displaying the tree structure on the computing device; and
selecting a sixth hypertext link associated with a sixth WWW resource from the first level of the tree structure to display the sixth WWW resource on the computing device, the sixth hypertext link corresponding to a sixth identifier of web resources, the sixth identifier included in the search results separate from the first and second identifiers.

23. The method of claim 28, further comprising:
pruning the corresponding identifier for at least one WWW resource from the first level of the tree structure.

24. The method of claim 28, further comprising:
selecting one or more WWW resources from the search results in conjunction with the providing of displayable information to the user device.

25. The method of claim 28, further comprising:
annotating the identifier for at least one WWW resource in the tree structure with ad hoc information.

26. A method for providing information concerning web resources, comprising:
receiving, from a web search engine, search results responsive to a query from a user device, the search results including at least first and second identifiers of web resources provided by first and second web servers, respectively; and
providing to the user device displayable information concerning a tree structure having at least one node, wherein the first and second identifiers are arranged at a first level of the tree structure relative to the node, and at least a third identifier is arranged at a second level of the tree structure relative to the node and in a hierarchical relation to the first identifier, the third identifier identifying a web resource which is provided by the same web server as, and accessible through, the web resource identified by the first identifier.

27. An apparatus for providing information concerning web resources, comprising:
an organizing tool adapted receive, from a web search engine, search results responsive to a query from a user device, the search results including at least first and second identifiers of web resources provided by first and second web servers, respectively;
wherein the organizing tool is also adapted to provide the user device displayable information concerning a tree structure having at least one node, wherein the first and second identifiers are arranged at a first level of the tree structure relative to the node, and at least a third identifier is arranged at a second level of the tree structure relative to the node and in a hierarchical relation to the first identifier, the third identifier identifying a web resource which is provided by the same web server as, and accessible through, the web resource identified by the first identifier.

28. A method for providing information concerning World Wide Web (WWW) resources, comprising:
receiving, from a web search engine, search results responsive to a query from a computing device, the search results including at least first and second identifiers of WWW resources provided by first and second WWW servers of the Internet, respectively;
providing to the computing device displayable information concerning a tree structure having at least one node, wherein the first and second identifiers are arranged at a first level of the tree structure relative to the node, and at least a third identifier is arranged at a second level of the tree structure relative to the node and in a hierarchical relation to the first identifier, the third identifier identifying a WWW resource which is provided by the same WWW server as, and accessible through, the WWW resource identified by the first identifier;
selecting a first hypertext link associated with a first WWW resource from the search results to display the first WWW resource on the computing device, the first hypertext link corresponding to the first identifier, the first WWW resource including one or more hypertext links; and
selecting a third hypertext link associated with a third WWW resource from the first WWW resource, the third hypertext link corresponding to the third identifier.
